(19) United States
(12) Patent Application Publication
(10) Pub. No.: US 2014/0196924 A1
(43) Pub. Date: Jul. 17, 2014

(54) DIELECTRIC ELEMENT FOR A HIGH-VOLTAGE INSULATOR WITH GREAT TRACTION STRENGTH

(71) Applicant: Sediver Societe Europeenne Disolateurs en verre et Composite, Nanterre Cedex (FR)

(72) Inventors: Jean-Marie George, Vichy (FR); Serge Tartier, Cusset (FR); Michel Chonier, Cusset (FR)

(21) Appl. No.: 13/578,724

(22) PCT Filed: Sep. 12, 2011
(86) PCT No.: PCT/FR11/52080

§ 371 Date: Aug. 13, 2012

(51) Int. Cl. H01B 3/08; H02G 7/05

(52) U.S. Cl. CPC H01B 3/084; H02G 7/05
USPC 174/44; 174/212; 174/145

(57) ABSTRACT

A dielectric element (2) for a high-voltage insulator (1) of very great traction strength, greater than 700 kN, of the type comprising a toughened glass body of revolution about a longitudinal axis (A) having a hollow head (6) extended by a ribbed shed (7). It has a profile that defines a creepage distance lying in the range 550 mm to 800 mm for an outside diameter (DJ) of the shed (7) that lies in the range 380 mm to 450 mm and a pitch (P) that lies in the range 260 mm to 290 mm, said dielectric element also presenting weight lying in the range 10 kg to 13 kg.

### CROSS REFERENCE TO RELATED APPLICATION(S)

This application is a 35 U.S.C. §371 of National Phase Entry Application from PCT/FR2011/052080, filed Sep. 12, 2011, designating the United States, the disclosure of which is incorporated herein by reference in its entirety.

### TECHNICAL FIELD

The invention relates to the field of high-voltage electrical insulators for holding overhead electrical energy transport lines in the air. The invention relates more particularly to high-voltage insulators of the “cap and pin” type suitable for being engaged in series one in another to form an insulating chain of insulators suitable for holding high-voltage power cables in the air by applying traction horizontally or vertically (suspension).

More particularly, the invention relates to the dielectric element or part included in this type of insulator. This element is generally in the form of a toughened glass body having a hollow head extended by a flared portion that forms a skirt or “shed”. A metal cap having a recess at its top is bonded to the outside surface of the head, and a metal pin having its end suitable for engaging with the top of the cap of an adjacent insulator in a chain of insulators is bonded in the internal cavity of the head.

Generally, the dielectric element is geometrically characterized by the outside diameter of the shed and by the pitch (inter-insulator spacing), which corresponds to the vertical distance between two identical points on two consecutive dielectric elements of a chain of insulators. In addition, the electrical insulation ability of the dielectric elements is characterized by measuring its creepage distance which is defined by the outer profile of the dielectric element, i.e. which is equal to the shortest path that can be traveled along the surface of the dielectric element between the cap and the metal pin. Finally, an insulator is characterized mechanically by its traction strength.

The dielectric element proper, the insulator, and a chain of insulators as a whole must all comply with requirements not only of electrical, mechanical, and chemical nature, but also with requirements concerning dimensions in order to enable them to comply with the standards in force, and in particular international standard IEC 60815. It is therefore necessary not only to profile the dielectric of each insulator in appropriate manner and to use a sufficient number of them in the chain, but also to take account of three-dimensional constraints. Once the insulating chain has been put into place it is usually either suspended vertically from a pylon to which it is attached, such that it extends practically parallel thereto, or else it is anchored to the pylon in a semi-horizontal manner. However in both configurations minimum safety distances are specified between the chain and the pylon and also between the chain and the ground, for the purpose of maintaining a maximum level of safety even under extreme atmospheric conditions such as wind and snow. This means that regardless of the level of pollution, it is not possible to increase the length of the chain without limit, which length is directly associated with the number of insulators used, nor even is it possible to increase its width without limit, which width is defined directly by the outside diameter of the sheds of the dielectric elements.

It can thus be seen that in order to design a new electrical insulator that is specific for high voltages and high levels of pollution, a multitude of conditions must be satisfied, in particular relating to the profile of the dielectric, which profile is often the result of a compromise between having a creepage distance that is sufficiently long and a three-dimensional size that is sufficiently compact, where said size is defined both by the shed diameter and by the pitch of the insulator.

### Prior art

Patent document FR 2 680 041 discloses a dielectric electrical insulator made of glass and suitable for use in insulating chains for cables at high voltages, greater than 90 kilovolts (kV), which insulator comprises a dielectric element having a shed of diameter lying in the range 320 millimeters (mm) to 350 mm and a pitch lying in the range 140 mm to 150 mm, and forming a creepage distance lying in the range 550 mm to 575 mm.

The invention seeks to provide a cap and pin type electrical insulator as defined above, but that is adapted for use with very-high or ultra-high voltages. In this range of voltages, cables are of diameters that are greater than standard and they are thus very heavy and they need to be supported by chains of insulators.

At present, in order to support such cables, use is made of multiple chains of insulators of the type described above. For example, for such ultra-high voltage lines, two, three, or four chains of insulators are used in which each insulator presents traction strength of the order of 550 kilonewtons (kN). There are also circumstances in which four chains of insulators are used, with each insulator presenting traction strength of about 300 kN, thereby forming an assembly having traction strength of about 1200 kN.

Such multiple chains are heavy, complex, and expensive, since they require multiple fastening and connection fittings. Furthermore, the more complex the set of chains, the greater the difficulty involved in maintenance operations or in working on live cables.

The development of dielectric insulators made of porcelain has been envisaged, however they are heavier than insulators using a toughened glass dielectric and they are also more bulky because they present a pitch that is greater than that of an insulator having a toughened glass dielectric. This is explained in particular by the fact that the maximum stresses that can be accepted by porcelain are smaller than those that can be accepted by toughened glass, so the size of the head of the dielectric of the insulator is always seen to be greater when using porcelain.

Electrical insulators using a toughened glass dielectric thus presently provide traction strength that is limited to 550 kN.

The object of the invention is to propose a solution for an electrical insulator with a toughened glass dielectric that is capable of presenting very great traction strength, greater than 700 kN and up to 900 kN, and that is capable of satisfying the requirements of very-high or ultra-high voltage applications while minimizing weight and pitch.

### SUMMARY OF THE INVENTION

To this end, the invention provides a dielectric element for a high-voltage insulator of very great traction strength, of the type comprising a toughened glass body of revolution about a longitudinal axis, comprising a hollow head extended by a ribbed shed, characterized in that it has a profile shape that defines a creepage distance lying in the range 550 mm to 800 mm for an outside diameter of the shed lying in the range 380 mm to 450 mm and a pitch lying in the range 260 mm to 290 mm and preferably lying in the range 270 mm to 280 mm, the dielectric element also presenting weight lying in the range 10 kilograms (kg) to 13 kg

said, the shed having four annular internal ribs comprising a first rib, a second rib shorter than the first rib along the longitudinal axis, a third rib coplanar with the second rib in a plane perpendicular to the longitudinal axis, and a fourth rib shorter than said second and third ribs along the longitudinal axis thereby making it possible to achieve the longest creepage distances.

With this arrangement, it is possible simultaneously to have a maximum creepage distance, a minimum pitch, and maximum mechanical strength. Maximizing performance in this way is particularly applicable for chains of insulators mounted by anchoring in a substantially horizontal position, which is the position in which the greatest mechanical loads are imposed.

The dielectric element of the invention may present the following features:

said head has a height measured between its top and said shed that lies in the range 100 mm to 120 mm, an outside diameter that lies in the range 105 mm to 120 mm, and an internal cavity of inside diameter lying in the range 55 mm to 65 mm;

said head has a height measured between its top and said shed that lies in the range 100 mm to 120 mm, an outside diameter that lies in the range 105 mm to 120 mm, and an internal cavity of inside diameter lying in the range 65 mm to 75 mm;

said first rib has a height measured from the top of said head lying in the range 195 mm to 205 mm, said second and third ribs having a respective height measured from the top of the head lying in the range 175 mm to 180 mm, and said fourth rib having a height measured from the top of the head lying in the range 165 mm to 170 mm;

said first rib has a diameter lying in the range 310 mm to 340 mm, said second rib has a diameter lying in the range 250 mm to 270 mm, said third rib has a diameter lying in the range 190 mm to 220 mm, and said fourth rib has a diameter lying in the range 140 mm to 160 mm;

said shed has a wall thickness lying in the range 11 mm to 18 mm; and

said head has seven to twelve corrugations on the outside and seven to fourteen corrugations on the inside.

The invention also provides a high-voltage electrical insulators of the cap and pin type, having very great traction strength, characterized in that it includes such a dielectric element having bonded thereon a metal cap and a metal rod, the high-voltage insulators presenting traction strength greater than 700 kN.

The invention also provides a chain of high-voltage electrical insulators of very great traction strength, characterized in that it comprises a plurality of high-voltage insulators as defined above engaged in series one in another.

The invention also provides an electrical installation including an electrical energy transport cable held in the air by a chain of high-voltage electrical insulators of very great traction strength as defined above.

### BRIEF DESCRIPTION OF THE DRAWINGS

The present invention can be better understood and other advantages appear further on reading the following detailed description of an embodiment given by way of non-limiting example and shown in the accompanying drawings, in which:

FIG. 1 is a diagrammatic view of a high-voltage insulator of very great traction strength and including a dielectric element of the invention;

FIG. 2 is a section view of the FIG. 1 dielectric element; and

FIG. 3 is a highly diagrammatic view of an electrical installation of the invention comprising a chain of high-voltage insulators having very great traction strength of the invention.

### DESCRIPTION OF AN EMBODIMENT

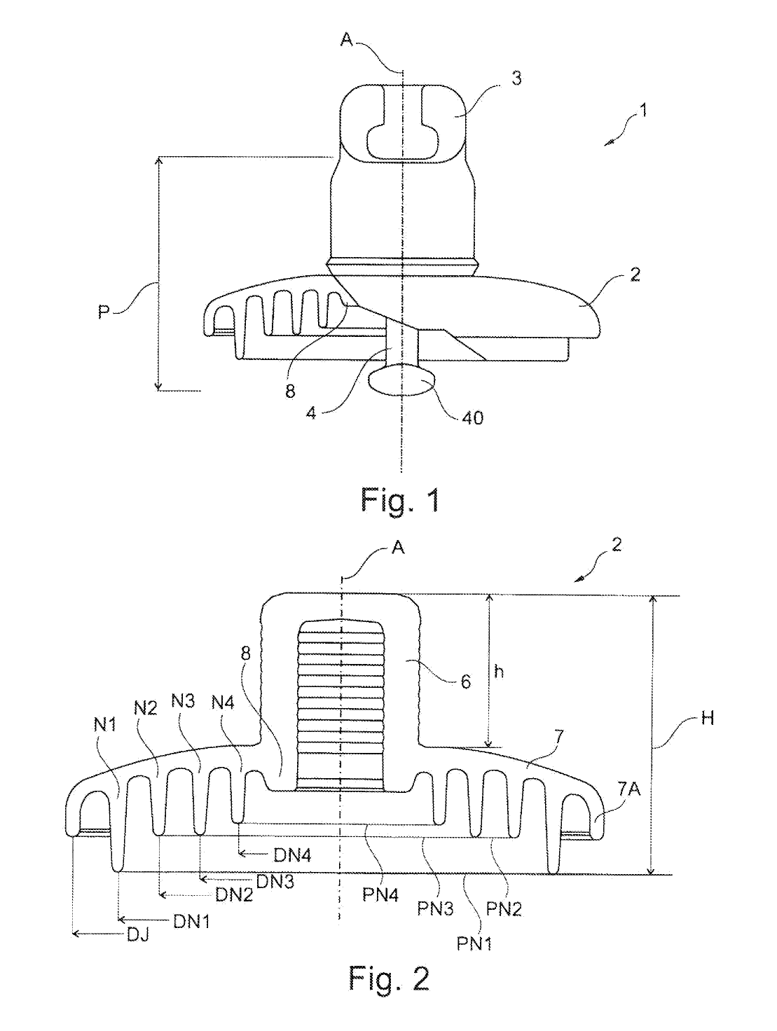

With reference to FIG. 1, the high-voltage insulator 1 of the invention comprises a dielectric element 2 having a metal cap 3 and a metal pin 4 bonded thereon with a cement or mortar (e.g. of the “Portland”, or aluminous, or calcium sulfoaluminate type), the cap having a recess at its top.

As can be seen in FIG. 1, the recess at the top of the metal cap 3 is of a shape that is complementary to the free end of the metal pin 4 so as to enable them to be inserted mutually one in the other in order to build up a chain of insulators connected in series.

According to the invention the high-voltage insulator 1 is designed to present very great traction strength, greater than 700 kN, its metal cap 3 may weigh about 11 kg, and the metal pin 4 may weigh about 2.5 kg, the weight of the bonding cement is about 0.85 kg.

The dielectric element 2 of the high-voltage insulator 1, shown in detail in FIG. 2, is a body of revolution about the longitudinal axis A that is made of toughened glass and that has a hollow head 6 that is cylindrical about the axis A and a ribbed skirt or “shed” 7 extending from the head 6 in a coaxial flared shape.

By way of example, the head 6 has an outside diameter lying in the range about 105 mm to 120 mm, in this example 117 mm, and an inside diameter (diameter of its internal cylindrical cavity) lying in the range about 55 mm to about 65 mm. The head 6 preferably has an inside diameter lying in the range about 65 mm to 75 mm, and in this example it is equal to 67.5 mm to within ±1 mm, enabling best mechanical properties to be achieved. With this particular range of values, the compromise between a creepage distance of sufficient length, small overall bulk, and good mechanical strength is optimized. The thickness of the finished wall at the top of the head 6 is about 20 mm, and is equal to 19 mm in this example.

As can be seen in FIG. 2, a sufficient number of corrugations are provided both on the outside surface of the head 6 that is bonded to the metal cap 3 and on the inside surface of the cavity of the head 6 that is bonded to the metal pin 4. In the example of FIG. 2, there are seven to twelve corrugations on the outside of the head and seven to fourteen on the inside of the head 6. The height h of the head 6 as measured between its top and the top of the shed 7 lies in the range about 100 mm to about 120 mm, and preferably in the range about 105 mm to about 115 mm, and it is equal to 111 mm in this example.

At the junction between the head 6 and the shed 7, a reinforcing projection 8 extends into the inside of the shed 7.

The height H of the dielectric element 2, as measured between the top of the head 6 and the lowest point of the shed 7 lies in the range about 190 mm to 210 mm, and is equal to 201 mm in this example. The shed 7 presents an outside diameter DJ in the plane PJ that is not less than 350 mm, and that preferably lies in the range 380 mm to 450 mm, and is equal to 400 mm in this example.

The shed 7 of the dielectric element 2 has internal annular ribs N1, N2, N3, and N4 that are coaxial with one another and with the peripheral edge 7A of the shed 7. In the particular profile of the dielectric element 2, the shed 7 has four annular internal ribs N1, N2, N3, and N4, with two adjacent ribs being coplanar in a plane perpendicular to the axis A.

The ribs N1-N4 have a section that presents a profile that tapers slightly. The diameter DN1 of the first rib N1 in the plane PN1 lies in the range 310 mm to 340 mm, and is equal to 323 mm in this example. The diameter DN2 of the second rib N2 in the plane PN2 lies in the range 250 mm to 270 mm, and is equal to 263 mm in this example. The diameter DN3 of the third rib N3 in the plane PN3 lies in the range 190 mm to 220 mm, and is equal to 203 mm in this example. The diameter DN4 of the fourth rib N4 in the plane PN4 lies in the range 140 mm to 160 mm, and is equal to 148.5 mm in this example.

The wall thickness of the shed 7 lies in the range 11 mm to 18 mm. From the peripheral edge 7A as far as the rib N1, the thickness of the shed is 11 mm. Between the ribs N1 and N2, the thickness of the shed is 12 mm. In the region of the ribs N2 and N3, the thickness of the shed is 13 mm. Between the ribs N3 and N4, the thickness of the shed is 15 mm. Between the rib N4 and the projection 8, the thickness of the shed is 18 mm.

As shown in FIG. 2, the rib N2 is shorter than the rib N1 along the axis A, the rib N3 has the same length as the rib N2, and the rib N4 is shorter than the ribs N2 and N3.

The rib N1 has a height measured from the top of the head 6 that lies in the range 195 mm to 205 mm, and is equal to 201 mm in this example. The ribs N2 and N3 have a common height measured from the top of the head 6 that lies in the range 175 mm to 180 mm, and equal to 175.5 mm in this example. Overall, these two ribs could be of different lengths, but they nevertheless lie within this range should the criteria of maximum creepage distance, minimum pitch, and maximum traction strength not all be looked-for simultaneously. The rib N4 has a height measured from the top of the head 6 that lies in the range 165 mm to 170 mm, and equal to 167 mm in this example.

In FIG. 2, it can also be seen that the outside edge 7A of the shed 7 is coplanar in the plane PJ with the ribs N2 and N3. The height of the edge 7A of the shed 7 measured from the top of the head 6 thus lies in the range 175 mm to 180 mm, and is equal to 175.5 mm in this example.

With this configuration of the ribs N1 to N4, of the head 6, and of the peripheral edge 7A of the shed 7, the dielectric element 2 of the high-voltage insulator 1 presents a creepage distance lying in the range 550 mm to 800 mm, preferably in the range 650 mm to 700 mm, and equal to 680 mm in this example. The pitch P of the insulator lies in the range 260 mm to 290 mm and preferably in the range 270 mm to 280 mm.

The weight of the toughened glass dielectric element 2 in this configuration lies in the range 10 kg to 13 kg, thereby enabling it to be molded and toughened with existing tooling, thus guaranteeing maintenance of physical performance and of fabrication quality.

Taking into consideration the weight of the metal pin 4, of the metal cap 3, and of the cement 5, the total weight of the high-voltage insulators 1 may lie in the range 24 kg to 30 kg, and preferably in the range 25 kg to 28 kg.

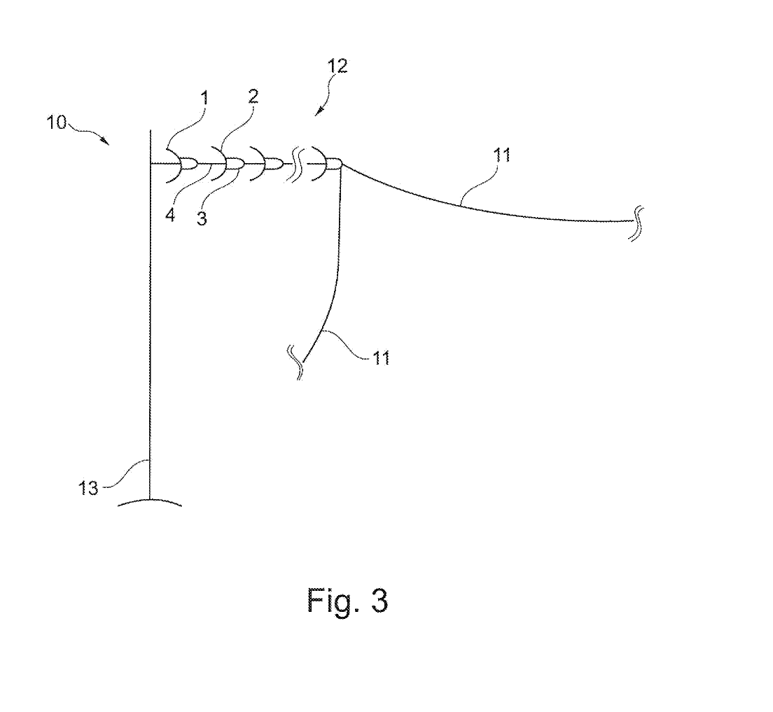

FIG. 3 shows an electrical installation 10 comprising an electrically conductive cable 11 held on a pylon type support 13 by a chain 12 of high-voltage insulators 1 connected together in series in succession one in another.

With a high-voltage insulator 1 that is optimized in accordance with the invention, presenting a creepage distance of 680 mm and a pitch of 270 mm for a shed outside diameter of 400 mm and a total weight of 26.165 kg, including 11 kg of toughened glass, it is possible to provide a chain of insulators that is 17.1 meters (m) long using 63 insulators giving a total creepage distance of 42,880 mm. A chain of insulators of this type is entirely compatible with lines designed to operate with direct current (DC) at a voltage of 800 kV.

1-10. (canceled)

11. A dielectric element for a high-voltage insulator of very great traction strength, comprising a toughened glass body of revolution about a longitudinal axis, having a hollow head extended by a ribbed shed, wherein said dielectric element has a profile shape that defines a creepage distance lying in the range 550 mm to 800 mm for an outside diameter of said shed lying in the range 380 mm to 450 mm and a pitch lying in the range 260 mm to 290 mm, said dielectric element also presenting weight lying in the range 10 kg to 13 kg, said shed having four annular internal ribs including a first rib, a second rib shorter than said first rib along said longitudinal axis, a third rib coplanar with said second rib in a plane perpendicular to said longitudinal axis, and a fourth rib shorter than said second and third ribs along said longitudinal axis.

12. A dielectric element according to claim 11, wherein said head has a height measured between its top and said shed that lies in the range 100 mm to 120 mm, an outside diameter that lies in the range 105 mm to 120 mm, and an internal cavity of inside diameter lying in the range 55 mm to 65 mm.

13. A dielectric element according to claim 11, wherein said head has a height measured between its top and said shed that lies in the range 100 mm to 120 mm, an outside diameter that lies in the range 105 mm to 120 mm, and an internal cavity of inside diameter lying in the range 65 mm to 75 mm.

14. A dielectric element according to claim 11, wherein said first rib has a height measured from a top of said head lying in the range 195 mm to 205 mm, said second and third ribs having a respective height measured from the top of the head lying in the range 175 mm to 180 mm, and said fourth rib having a height measured from the top of said head lying in the range 165 mm to 170 mm.

15. A dielectric element according to claim 14, wherein said first rib has a diameter lying in the range 310 mm to 340 mm, said second rib has a diameter lying in the range 250 mm to 270 mm, said third rib has a diameter lying in the range 190 mm to 220 mm, and said fourth rib has a diameter lying in the range 140 mm to 160 mm.

16. A dielectric element according to claim 11, wherein said shed has a wall thickness lying in the range 11 mm to 18 mm.

17. A dielectric element according to claim 11, wherein said head has an outside and an inside, and wherein said head has seven to twelve corrugations on the outside and seven to fourteen corrugations on the inside.

18. A high-voltage insulator of the cap and pin type, comprising a dielectric element according to claim 11 having bonded thereon a metal cap and a metal rod, the high-voltage insulators presenting traction strength greater than 700 kN.

19. A chain of high-voltage electrical insulators comprising a plurality of high-voltage insulators according to claim 18 engaged in series one in another.

20. An electrical installation including an electrical energy transport cable held in the air by a chain of high-voltage insulators according to claim 19.
